(19) United States
(12) Patent Application Publication
(10) Pub. No.: US 2015/0220217 A1
(43) Pub. Date: Aug. 6, 2015

(54) MULTILINGUAL INTERFACE AND INPUT DEVICE

(71) Applicant: Ali Salman ALSHAFAI, Washington, DC (US)

(72) Inventor: Ali Salman ALSHAFAI, Washington, DC (US)

(21) Appl. No.: 14/173,413

(22) Filed: Feb. 5, 2014

(51) Int. Cl. G06F 3/0482; G06F 3/0488

(52) U.S. Cl. CPC G06F 3/0482; G06F 3/04886

(57) ABSTRACT

In selected embodiments, an input device having a housing, a display screen attached to the housing and a memory that stores input configuration layouts for a plurality of countries. The input device also includes a processor which causes the display screen to display a language key which when selected by a user causes the display of a plurality of languages. The user can then select a particular language as well as a country corresponding to the selected language. Based on these selections and in selected embodiments, the processor displays on the display screen of the input device a plurality of keys each having a character corresponding to the selected language as well as a layout configuration of the keys which corresponds to the input layout configuration of the selected country. Users of the input device can therefore interface with systems in various countries without having to worry about language barriers.

### GRANT OF NON-EXCLUSIVE RIGHT

This application was prepared with financial support from the Saudia Arabian Cultural Mission, and in consideration therefore the present inventor(s) has granted The Kingdom of Saudi Arabia a non-exclusive right to practice the present invention.

### BACKGROUND

Over the years, the world has transititioned from an isolated environment having local economies to a more globalized environment in which economies of a multitude of countries are intertwined. Trade and travel between different countries and continents is at an all time high thanks to advancements in a variety of transportation technologies. Further, advancements in computer technology have proliferated to all corners of the globe thereby providing familiarity to most users.

However, although most people now have familiarity interfacing with a computer system, they are mostly used to doing so in their home language or a language they are most comfortable with. For example, input devices such as keyboards and touchpads contain characters and layout configurations based on a particular region and language. Therefore, when using an input device from an area foreign to a person, he or she may have difficulty using such an input device much less the computer system as whole. This greatly hinders a person's ability to conduct business, maintain communications and keep up to speed in a techonological world where people are accustomed to having access to information. Further, traveling with an input device is cumbersome and it is unknown if the input device will even be compatible with a system in a foreign area.

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

### SUMMARY

In selected embodiments, an input device having a housing, a display screen attached to the housing and a memory that stores input configuration layouts for a plurality of countries. The input device also includes a processor which causes the display screen to display a language key which when selected by a user causes the display of a plurality of languages. The user can then select a particular language as well as a country corresponding to the selected language. Based on these selections and in selected embodiments, the processor displays on the display screen of the input device a plurality of keys each having a character corresponding to the selected language as well as a layout configuration of the keys which corresponds to the input layout configuration of the selected country. Users of the input device can therefore interface with systems in various countries without having to worry about language barriers.

The foregoing paragraphs have been provided by way of general introduction, and are not intended to limit the scope of the following claims. The details of one or more implementations will be best understood by reference to the following detailed description taken in conjunction with the accompanying drawings. Other features, objects, and advantages will be apparent from the description and drawings, and from the claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a system in which the input device is connected to an external device according to one example;

FIG. 2 illustrates an exemplary input layout configuration displayed on the input device according to one example; and

FIG. 3 illustrates a flow chart describing the functionality of the input device according to one example;

FIGS. 4A and 4B illustrate the transition from one input layout configuration to another input layout configuration according to one example; and

FIG. 5 illustrates a hardware device configuration of the input device according to one example.

Like reference symbols in various drawing indicate like elements.

### DETAILED DESCRIPTION OF THE EMBODIMENTS

A more complete appreciation of the present advancements and many of the attendant advantages thereof will be readily obtained as the same becomes better understood by reference to the following detailed description when considered in connection with the accompanying drawings. However, the accompanying drawings and their exemplary depictions do not in any way limit the scope of the advancements embraced by the specification. The scope of the advancements embraced by the specification and drawings are defined by the words of the accompanying claims.

Selected embodiments are now described by referring now to the drawings, wherein like reference numerals designate identical or corresponding parts throughout the several views. It is noted that as used in the specification and the appending claims, the singular forms “a,” “an,” and “the” can include plural references unless the context clearly dictates otherwise.

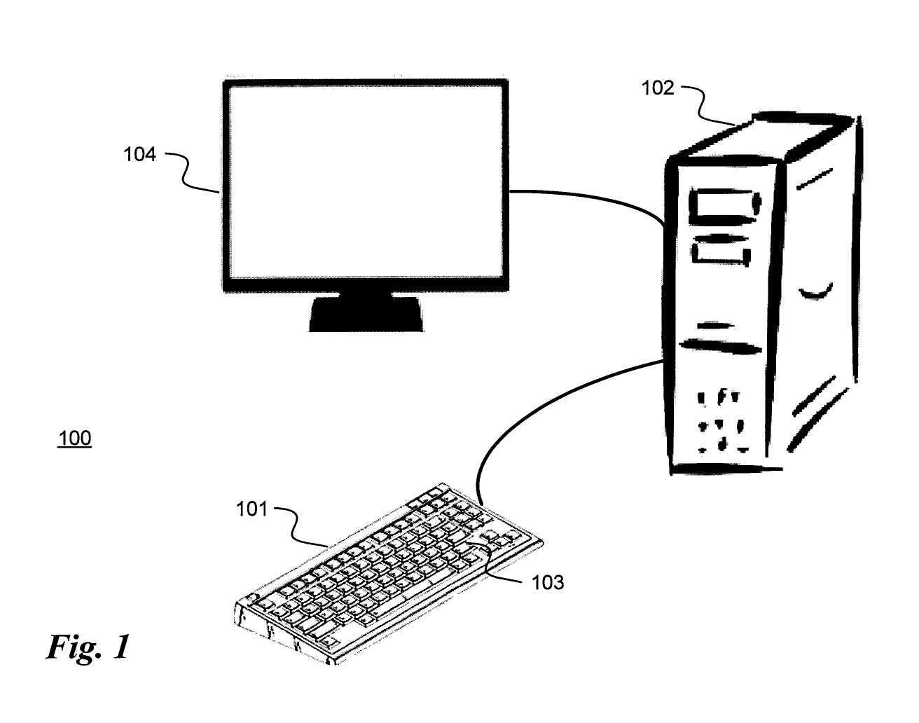

FIG. 1 illustrates a system in which the input device 100 is connected to an external device according to one example. As illustrated, the input device 100 has at least a housing 101 and a display 103. The housing 101 contains the hardware (described further below) of the input device 100 and has the display 103 connected to it. The display 103 can be any display as would be understood by one of ordinary skill in the art such as a touch-sensitive display panel. Although illustrated as covering an entire portion of the housing 101, the display 103 may cover a small portion of the housing 101. As shown in FIG. 1, the display 103 is displaying a virtual keyboard via the hardware/software of the input device 100. This feature is described further below.

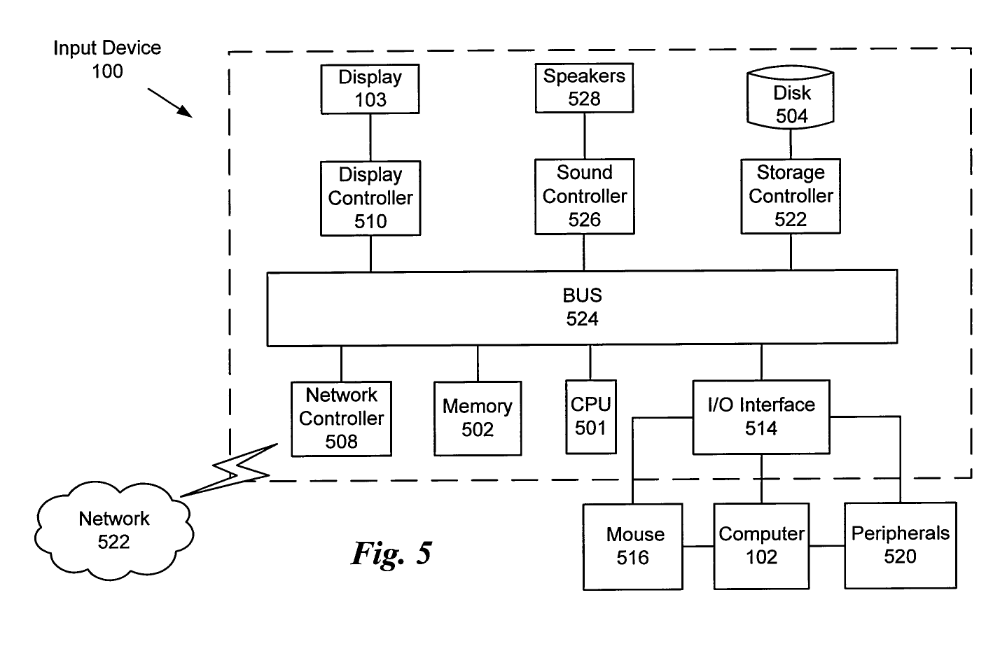

FIG. 1 also illustrates the connection of the input device 100 to a computer system having a computer 102 and a monitor 104. The computer 102 can be any computer as would be understood by one of ordinary skill in the art such as a PC, iMac or Laptop. The input device is connected to the computer system via an i/o interface such as a bus or serial cable as described further in FIG. 5. As shown in FIG. 1, the input device 100 can be used to input information into the computer 102 for processing and display on the monitor 104. For example, the input device can be used as a virtual keyboard in connection with the computer 102. The advantages of such a connection via the input device 100 are described further below.

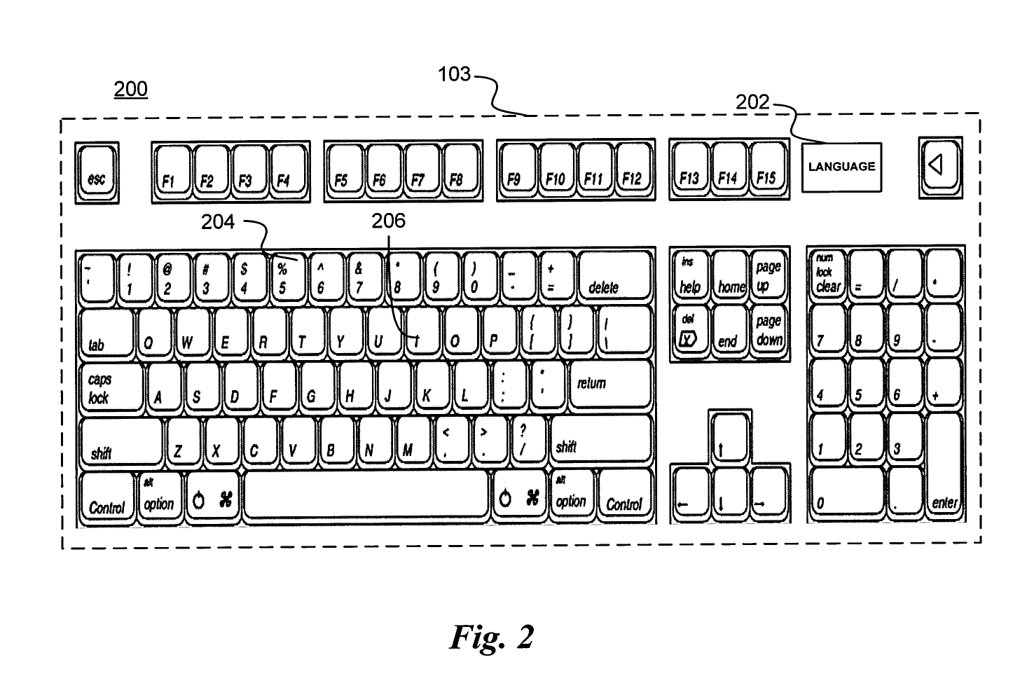

FIG. 2 illustrates an exemplary display of a virtual keyboard 200 on the display 103 of the input device 100. In particular, the keyboard layout is similar to a keyboard layout provided by Apple™. The virtual keyboard contains a plurality of virtual keys 204 each having a character 206 corresponding to a language. For example, the keyboard illustrated in FIG. 2 contains keys with characters corresponding to languages such as English, Spanish and French. The virtual keyboard is also displayed in a particular layout corresponding to a certain country and in relation to the language. For example, although many of the characters are the same, the layout of the keyboard is based on a United States keyboard layout as it does not have particular symbols and characters unique to what would appear on a standard French or Spanish keyboard layout.

Therefore, for the purposes of the following discussion, it is assumed that the computer system illustrated in FIG. 1 is located in the United States at a hotel and that it is connected to a standard mechanical keyboard having a layout identical to that illustrated in FIG. 2. In this case, it may be difficult for someone from France who is visiting the hotel in the United States to use the computer 102. This problem would only be exacerbated if the visitor was from a country such as the Kingdom of Saudi Arabia (KSA) in that the characters would not even look the same. This could effectively prevent a user from being able to effectively use the computer 102. In other words, the visitor from the KSA may only be comfortable using a keyboard having characters corresponding to Arabic and having a layout configuration similar to how keyboard configurations are in the KSA.

Accordingly, in exemplary embodiments, the input device 100 also displays on the virtual keyboard 200 configuration a language key 202 that can be used to change the language and layout configuration of the keyboard 200. The language key 202 may display a particular character like a question mark or another universally known symbol such that a user will know to select this key in order to change the language and layout configuration of the keyboard 200. In selected embodiments, the language key 202 may also display the word “language” or another word in a particular language and then display that word in a different language at predetermined intervals to alert the user that the language key 202 can be used to change the language and layout configuration of the keyboard 200. This process is described further below.

It is noted that in selected embodiments the language key 202 can be at any location of the keyboard or can be configured to be the only key displayed on the display 103 of the input device 100 such that whenever a new user decides to use the input device 100 the input device 100 will automatically inquire as to the language the user wishes to proceed with. In that example, any action taken by the user such as moving the input device 100, picking up the input device 100, or pressing a part of the input device 100 such as the display 103 can cause the input device 100 to display the language selection key 202 or a language selection screen as described further below. This can be accomplished through the use of accelerometers and touch-sensitive capacitive or resistive touch technology as would be understood by one of ordinary skill in the art. In other selected embodiments, the language key 202 may be a separate mechanical key that is part of the housing 101 of the input device 100.

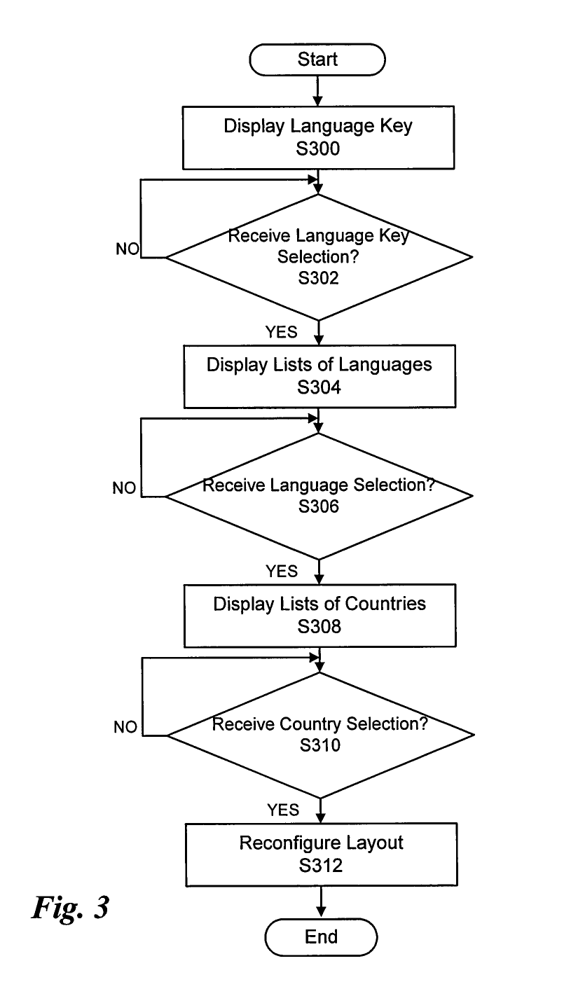

FIG. 3 illustrates a flow chart describing the functionality of the input device 100 according to one example. First, the input device 100 displays the language key 202 on the display 103 of the input device 100 at step S300 and as described previously herein. The input device then determines whether the language key 202 has been selected or not by the user at step S302. If not, the input device 100 continuously polls for a selection of the language key 202 by the user. Once the language key is selected by the user at step S302, the process proceeds to step S304 at which point the input device 100 displays on the display 103 a list of languages (not illustrated) from all over the world. The list of languages can be displayed in any format on the display 103 such that a user can select a particular language. For example, the list of languages will include a variety of different characters and spellings based on the particularities of the language.

Once the languages have been displayed on the display 103 of the input device 100, the process proceeds to step S306 to determine whether or not a user has selected a particular language. If a language is not selected, the input device 100 continues to await a selection from the user for a predetermined period of time. Once a language is selected by the user, the process proceeds to display on the display 103 a list of countries (not illustrated) at step S308. In selected embodiments and at this point, the input device may transition to display everything in the language selected previously by the user at step S306. This will help the user proceed to effectively use the input device 100 with less chance of error, confusion and frustration.

The list of countries can be displayed in a variety of manners on the display 103. In selected embodiments, the list of countries is displayed as a world map such that the user can simply select a particular country from the world map. The list of countries may also be displayed via various flags for each country such that the user can select a flag to which he is familiar with to identify his home country. In certain embodiments, the input device 100 will automatically filter the list of countries based on the language selected by the user at step S306. In other words, if the user selects French language, the input device 100 may only display those countries where French is primary language such as France or Canada. Further, in selected embodiments and on the world map, particular countries may be highlighted based on the previously selected language or only select flag may be displayed based on the selected language. This will make the selection easier for the user and will prevent the chance of the user accidentally selecting the wrong country.

Next, the input device 100 continuously polls at step S310 to determine whether a selection of a country has been made by the user. If a selection has not been made then the input device 100 keeps polling until a selection is made or a timeout occurs. Once a selection is made by the user at step S310, the process proceeds to step S312 at which point the input device displays an input layout configuration of the keyboard corresponding to both the language and the country selected by the user as described further below. The user can then use a keyboard 200 layout in which he is comfortable with and can use the computer 102 in a foreign country without any complications.

In selected embodiments, it is noted that the input device 100 can reset the display screen back to step S300 after a predetermined period of time in which no selections were made by the user. Therefore, it may be that a user was initially interested in using the input device and then decided not to but left the interface up and running. Therefore, in order to avoid confusion with any future users who aren't familiar with the layout or the language of the previous user, the input device 100 can automatically reset the system back to the initial screen having the keyboard 200 layout and/or the language selection key 202 only.

It should be noted that in selected embodiments the steps identified in FIG. 3 can be in different order or certain steps may be omitted. For example, the user may first select a flag of a country at which point a list of languages will be displayed corresponding to languages spoken in the country represented by the selected flag. Similarly, a user could first select a country from the displayed world map at which point a list of flags or languages will be displayed such that a user can select a particular language corresponding to the selected country from the displayed world map. Further, the list of languages, flags or countries can also be displayed on the input device 100 itself alone or in combination with the display 103. A user can then easily select something via a touch input display on the input device 100.

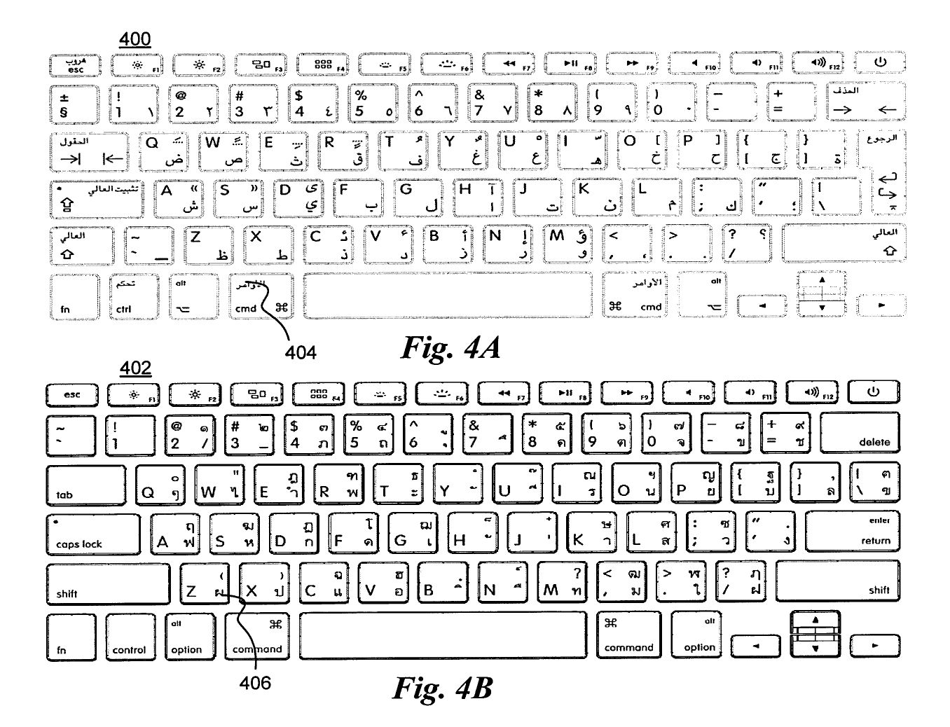

FIGS. 4A and 4B illustrates the transition from one input layout configuration to another input layout configuration according to one example. In other words, FIG. 4A illustrates an input layout configuration 400 of a keyboard in an initial state having Arabic characters 404. Therefore, a previous user of the input device may have selected Arabic as the language to feel comfortable with Arabic characters and then selected the KSA to receive an input layout configuration similar or identical to standard keyboard layouts in the KSA. However, when a new user wants to use the input device 100 to interact with the computer 102, the new user may have to select a different language.

In other words, the user can select the language key 202 in order to bring up the list of languages as described in steps S300-S304 of FIG. 3. Once the user sees the list of languages on the display 103 of in the input device 100, the user can select a particular language that he is most comfortable with as described in step S306 of FIG. 3. For example, if the new user is from Thailand the user may select Thai as their language as well as Thailand the country for the input layout configuration as described in step S310 of FIG. 3. At this point, the input device 100 will display an input configuration layout 402 based on how keyboards are traditionally laid out in Thailand. As illustrated in FIG. 4, it can be seen that the characters 406 have changed from the Arabic characters 404 to correspond to the language selection by the user and also that the input layout configuration 402 is different than the input layout configuration 400. A user from Thailand who is visiting a hotel in a foreign country can therefore use a computer and not worry about any language barriers or being confused by the layout of a keyboard in a foreign jurisdiction. It is also optional for input device 100 to display bi-lingual characters on the keyboard depending on the layout of the keyboard. For example, if a user is switching from English to French, the input device 100 may display both French and English characters on the keyboard at the same time. Further, as English is widely considered as a universal language, the language button 202 can be programmed to automatically switch to English as a default or a separate English language button can be provided for automatically switching to English if that is not the current language. English input layout configurations 400 could also then automatically be displayed so that a user can select a familiar layout.

In selected embodiments, once a user selects a language at step S306 of FIG. 3, the system may automatically filter input layout configurations of keyboards and provide the user with a virtual display of various keyboard configurations relating to the language. In other words, the input device 100 may filter the input layout configurations stored in memory to identify to the user only those layouts that relate to the language selected by the user. In this case, the user does not need to select a country but can select a keyboard configuration layout by sight based on their familiarity with the layout.

In selected embodiments, the input device 100 can also output the language and country information selected by the user to the computer 102 to update the computer 102 it self. For example, once the user has selected a language via the display 103 of the input device 100, the input device 100 may transmit the selection to the computer 102 via any connection, such as wireless or wired, as would be understood by one of ordinary skill in the art and as explained further below. Once the computer 102 receives the language selection any applications running on the computer 102 can switch to present information in the language selected by the user via the language key 202. For example, the Operating System of the computer 102 upon receive the language selection from the input device can switch to that language. The user can then easily use the computer 102 in addition to the input device 100.

The input device 100 can also transmit the country selection to the computer 102 such that applications of the computer 102 may change how they operate based on the selected country. For example, if a user selected the French language and France as a country, the operating system of the computer 102 may update the time display to correspond to the time in France as well as how it would be displayed in France. This could also include changes made to the calendar based on the country selected.

The ability for the computer 102 to update its setting based on the reception of a language and country from the input device 100 could be accomplished via software installed on the computer 102. This software could be installed ahead of time or come preinstalled with the computer 102 itself either separate or as part of the operating system. The software could also be automatically installed upon connecting the input device 100 to the computer 102.

FIG. 5 illustrates a hardware layout of the input device 100 according to one example. Specifically in FIG. 5, the input device 100 includes a CPU 501 which performs the processes described above. The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the input device 100 communicates, such as a server or computer.

Further, the claimed advancements may be provided as a utility application, background daemon, or component of an operating system, or combination thereof, executing in conjunction with CPU 501 and an operating system such as Microsoft Windows 7, UNIX, Solaris, LINUX, Apple MAC-OS and other systems known to those skilled in the art.

The memory 502 and disk 504 also may be utilized in selected embodiments to store a plurality of input layout configurations for keyboards all over the world and for each country. The memory 502 and disk 504 also store the list having each language as well as character information from every language that can be used to provide the characters on each key of the input layout configuration for a particular country. Each input layout configuration can be mapped to particular characters or a subset of characters of a particular language such that different input layout configurations may use different character sets of the same language and be displayed in a different fashion based on the input configuration layout of the particular country.

CPU 501 may be a Xenon or Core processor from Intel of America or an Opteron processor from AMD of America, or may be other processor types that would be recognized by one of ordinary skill in the art. Alternatively, the CPU 501 may be implemented on an FPGA, ASIC, PLD or using discrete logic circuits, as one of ordinary skill in the art would recognize. Further, CPU 501 may be implemented as multiple processors cooperatively working in parallel to perform the instructions of the inventive processes described above.

The input device 100 in FIG. 2 can also include a network controller 508, such as an Intel Ethernet PRO network interface card from Intel Corporation of America, for interfacing with network 522. As can be appreciated, the network 522 can be a public network, such as the Internet, or a private network such as an LAN or WAN network, or any combination thereof and can also include PSTN or ISDN sub-networks. The network 522 can also be wired, such as an Ethernet network, or can be wireless such as a cellular network including EDGE, 3G and 4G wireless cellular systems. The wireless network can also be WiFi, Bluetooth, or any other wireless form of communication that is known.

The input device 100 may also further includes a display controller 510, such as a NVIDIA GeForce GTX or Quadro graphics adaptor from NVIDIA Corporation of America for interfacing with display 103 attached to the housing 101 of the input device 100 such as a touch-sensitive display as would be understood by one of ordinary skill in the art. A general purpose I/O interface 514 interfaces with a mouse 516 and/or a computer 102 and/or a variety of peripherals 520 including a monitor 104 and printers and scanners, such as an OfficeJet or DeskJet from Hewlett Packard. The input device 100 can also be externally connected to a power source to provide power therein or can receive power via a connection to an external device such as computer 102. Further, any of the connection described herein can also be wireless through technologies such as Bluetooth or RF.

A sound controller 526 may also be provided in the input device 100 such as Sound Blaster X-Fi Titanium from Creative, to interface with speakers/microphone 528 thereby providing sounds and/or music.

The general purpose storage controller 522 connects the storage medium disk 504 with communication bus 524, which may be an ISA, EISA, VESA, PCI, or similar, for interconnecting all of the components of the input device 100. A description of the general features and functionality of the display 103, mouse 516, as well as the display controller 510, storage controller 522, network controller 522, sound controller 526, and general purpose I/O interface 514 is omitted herein for brevity as these features are known.

In selected embodiments, the input device 100 is a device having a housing 101 containing the above-identified hardware and a display 103 which is connected to and covers a majority of the housing 101.

In selected embodiments, the input device 100 can be a separate device connected to an external device such as a computer 102 and as previously described herein or could also be part of a computer. For example, the input device 100 could be the input device connected to a laptop instead of a mechanical keyboard of a laptop. This provides numerous advantages. First, the laptop, which is designed for travel, can be used all over the world by various people without confusion as the language and the input layout configuration could be changed based on who is using the laptop. This also creates the advantage of allowing people to easily transfer or sell their laptops to people in various countries without having to worry about a surplus or lack of computers with particular pre-molded keyboards. This would further help reduce manufacturing costs as a single input device could be manufactured for every laptop.

Further advantages are present based on the use of the input device 100. Heavily traveled places such as airports, hotels and business centers around the world could use the input device 100 to allow people from all over the world to easily use the same computer 102 without confusion or requiring extensive changes. This saves costs on the part of the airports, hotels and business centers while also providing an advertising point to potential visitors who would appreciate the ease of use of their facilities.

In selected embodiments, having a single language key 202 provides an extremely easy-to-use input device 100 that could be used by anyone from any country. Users would also gain the advantage of being able to easily use different computer systems in different areas as required. Further, the input device 100 makes it seem like the user is using a computer is his or her home country. Further, by allowing the computer itself to update the language and country settings based on selections from the user on the input device the user can further get a sense of comfort as if they were using a computer in their home country.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Any processes, descriptions or blocks in flowcharts described herein should be understood as representing modules, segments, or portions of code which include one or more executable instructions for implementing specific logical functions or steps in the process, and alternate implementations are included within the scope of the exemplary embodiment of the present advancements in which functions may be executed out of order from that shown or discussed, including substantially concurrently or in reverse order depending upon the functionality involved.

Obviously, numerous modifications and variations of the present advancements are possible in light of the above teachings. It is therefore to be understood that within the scope of the appended claims, the present advancements may be practiced otherwise than as specifically described herein.

1. An input device for users from various countries, comprising:
a housing;
a display screen attached to the housing;
a memory configured to store input configuration layouts for a plurality of countries; and
a processor programmed to
display on the display screen a language key,
display, on the display screen and in response to selection of the language key, a list of languages,
display, on the display screen and in response to the selection of a language, a list of countries, and
display, on the display screen and in response to the selection of a country,
a plurality of keys each having a character of the selected language, and
the plurality of keys in a layout configuration corresponding to an input layout configuration of the selected country.

2. The input device according to claim 1, wherein in response to a selection of the language, the processor is further programmed to display the list of countries by name or via a world map.

3. The input device according to claim 2, wherein the processor further displays the list of countries by country flags.

4. The input device according to claim 1, wherein the language key indicates a particular language and the particular language indicated changes at a predetermined interval.

5. The input device according to claim 4, wherein until the language key is selected, the language key is the only key displayed on the display screen.

6. The input device according to claim 1, wherein the input device is connected to a computer.

7. The input device according to claim 6, wherein the processor is further programmed to output the selected language to the computer, the computer receiving the selected language and modifying a setting of at least one application such that the at least one application presents information in the selected language.

8. The input device according to claim 7, wherein the processor is further programmed to output the selected country to the computer, the computer receiving the selected country and modifying the setting of at least one application based on the selected country.

9. The input device according to claim 8, wherein the at least one application includes the operating system.

10. The input device according to claim 3, wherein the list of countries is filtered based on the selected language.

11. A method for users from various countries to input information via an input device, comprising:
storing, in a memory, input configuration layouts for a plurality of countries; and
displaying, via a processor and on a display screen attached to a housing of the input device, a language key,
displaying, on the display screen and in response to selection of the language key, a list of languages,
displaying, on the display screen and in response to the selection of a language, a list of countries, and
displaying, on the display screen and in response to the selection of a country,
a plurality of keys each having a character of the selected language, and
the plurality of keys in a layout configuration corresponding to an input layout configuration of the selected country.

12. The method according to claim 11, further comprising:
displaying, in response to a selection of the language, the list of countries by name or via a world map.

13. The input device according to claim 11, wherein the language key indicates a particular language and the particular language indicated changes at a predetermined interval.

14. The input device according to claim 13, wherein until the language key is selected, the language key is the only key displayed on the display screen.

15. The input device according to claim 11, wherein the input device is connected to a computer.

16. The input device according to claim 15, further comprising:
outputting the selected language to the computer, the computer receiving the selected language and modifying a setting of at least one application such that the at least one application presents information in the selected language.

17. The input device according to claim 16, further comprising:
outputting the selected country to the computer, the computer receiving the selected country and modifying the setting of at least one application based on the selected country.

18. The input device according to claim 17, wherein the at least one application includes the operating system.

19. The input device according to claim 12, wherein the list of countries is filtered based on the selected language.

20. A non-transitory computer-readable medium storing computer-readable instructions thereon which when executed by a processor of an input device cause the input device to perform a method for users from various countries to input information, the method comprising:
storing input configuration layouts for a plurality of countries; and
displaying, on a display screen attached to a housing of the input device, a language key,
displaying, on the display screen and in response to selection of the language key, a list of languages,
displaying, on the display screen and in response to the selection of a language, a list of countries, and
displaying, on the display screen and in response to the selection of a country,
a plurality of keys each having a character of the selected language, and
the plurality of keys in a layout configuration corresponding to an input layout configuration of the selected country.
